(19) United States
(12) Patent Application Publication
(10) Pub. No.: US 2007/0019206 A1
(43) Pub. Date: Jan. 25, 2007

(54) Etching method and apparatus

(75) Inventor: Shuzoh Ohbuchi, Mihara-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/489,783

(22) Filed: Jul. 19, 2006

(30) Foreign Application Priority Data
Jul. 19, 2005 (JP) JP2005-208589

(51) Int. Cl. G01B 11/02

(52) U.S. Cl. 356/504

(57) ABSTRACT

A to-be-etched substrate is illuminated by two lights each having a different wavelength coming from a light source in a light source detector section. The lights are reflected on the to-be-etched substrate. The two reflected lights as a result of reflection on the to-be-etched substrate each include an interfered light, which is generated by the lights reflected on the surface of the layer to be etched, and a boundary between the layers to be etched. A detector in a light source detector section converts the intensity of the received two interfered lights into electric signals for output to a control section. The control section calculates the etching speed from the frequency of either of the two interfered lights whichever having the larger amplitude. Based on thus calculated etching speed and the time taken for the etching operation, the etching depth is calculated.

### CROSS-REFERENCE TO RELATED APPLICATION

This application claims priority to Japanese Patent Application No. JP 2005-208589, which was filed on Jul. 19, 2005, the contents of which, are incorporated herein by reference, in their entirety.

### BACKGROUND OF THE INVENTION

1. Field of the Invention

The present invention relates to an etching method and apparatus for etching a multilayer film formed by crystal growth on a substrate.

2. Description of the Related Art

The demand for better semiconductor device characteristics has been growing year by year, and consequently the need for higher processing precision has been accelerated more than ever. For example, the processing precision is also required to be high for the etching depth at the time of etching a layer to be etched.

For improvement of the processing precision as to the etching depth, a related technology describes the etching method using a layer for use to detect an etching endpoint, i.e., a so-called etching stop layer. With this etching method, first of all, a semiconductor substrate is formed thereon with a layer of a predetermined thickness for use to detect an etching endpoint. This layer has the index of refraction higher than the semiconductor substrate. On such an etching endpoint detecting layer, another semiconductor layer is then formed with the index of refraction lower than the etching endpoint detecting layer so that a mask is formed. The resulting layer formation is then exposed to laser light of a predetermined wavelength, and the reflected light is monitored. During such monitoring, the etching operation is stopped when the etching endpoint detection layer is detected. For more details, refer to Japanese Unexamined Patent Publication JP-A 8-181387 (1996), for example. If for dry etching, there is an etching method of forming a layer called marker layer having a different composition ratio, and stopping the etching operation when the marker layer is detected.

Another related technology describes an etching apparatus that calculates the etching depth based on the frequency distribution as a result of frequency analysis using the maximum entropy method. In this etching apparatus, an etching object is exposed to coherent light, e.g., laser light, and the frequency analysis is conducted with respect to signals as a result of interference of light due to the light reflection on the surface of the etching object. From the result of the frequency analysis, the etching speed is calculated for use as a calculation basis for the etching depth together with the time taken for the etching operation. This method allows monitoring of the etching depth even when the etching object has no base such as substrate, and enables to stop the etching operation when the etching reaches any desired depth. For more details, refer to Japanese Patent No. 2545948, for example.

The problem with the technology is that the etching depth may not be calculated with precision because the interfered light is distorted periodically at a specific phase. For the purpose of solving such a problem, further another related technology describes a method of detecting the etching depth. In the method, an etching object is exposed to light varying in wavelength so that the etching depth is calculated. By exposing the etching object to light varying in wavelength as such, the interfered light can be plurally detected. Accordingly, even when one interfered light is distorted at a specific phase, another interfered light can serve as a complement thereto so that the etching depth can be detected with precision. For more details, refer to Japanese Unexamined Patent Publication JP-A 2001-210625.

With the related technologies, the etching depth of the layer to be etched is calculated even when the layer to be etched has no base such as substrate based on the etching speed and the time taken for the etching operation. The etching speed is derived from the frequency of the interfered light as a result of light reflection on the area covered by the mask, i.e., the area not to be etched, and the light reflection on the area not covered by the mask, i.e., the area to be etched.

For etching of an etching film configured by a plurality of layers to be etched varying in index of refraction, i.e., multilayer etching film, the etching depth may be measured prior to etching using the interfered light generated due to light reflection on boundaries between the layers to be etched. FIGS. 7 and 8 both show such an exemplary method of measuring the etching depth using the interfered light generated due to light reflection on the boundaries between the layers to be etched.

FIG. 7 is a schematic diagram showing the configuration of an etching apparatus 3 in a related technology. The etching apparatus 3 includes a light source detector section 14, a dry etching chamber 20, and a control section (not shown). The light source detector section 14 includes a light source for emitting light such as laser light, and a detector for receiving a reflected light 50. The reflected light 50 is the light emitted from the light source, and reflected by a to-be-etched substrate 30 being an etching object. The dry etching chamber 20 dry-etches the to-be-etched substrate 30 disposed therein. The control section measures the etching depth based on the frequency of an interfered light found in the reflected light 50 received by the detector in the light source detector section 14. The dry etching chamber 20 includes a light transmitting window 21 that passes therethrough an incident light 40 coming from the light source in the light source detector section 14, and the reflected light 50 as a result of reflection on the to-be-etched substrate 30.

The incident light 40 coming from the light source detector section 14 passes through the light transmitting window 21, and the incident light 40 illuminates the to-be-etched substrate 30 disposed in the dry etching chamber 20. The incident light 40 illuminating the to-be-etched substrate 30 as such is reflected by the to-be-etched substrate 30, and the resulting reflected light 50 passes through the light transmitting window 21, and reaches the light source detector section 14. The reflected light 50 is then received by the detector in the light source detector section 14.

FIG. 8 is a diagram showing the cross section of the to-be-etched substrate 30 shown in FIG. 7. The to-be-etched substrate 30 is configured by an layer to be etched 32 formed on a substrate 31. The incident light 40 is the one directed from the light source detector section 14 shown in FIG. 7, and the incident light 40 illuminates the layer to be etched 32. The incident light 40 illuminating the layer to be etched 32 as such is partially directed to the layer to be etched as an incident light 40a, and the remaining portion thereof is reflected by an etching surface 33. The incident light 40a directed to the layer to be etched as such is partially directed to the substrate 31 as an incident light 40b, and the remaining portion thereof is reflected, as a reflected light 50a, by a boundary 34 with the substrate 31. Although FIG. 8 shows only one layer to be etched, the boundary 34 with the substrate 31 is presumed as a boundary between the layers to be etched.

In the reflected light 50, the reflected light as a result of reflection on the etching surface 33 is overlaid with the interfered light, i.e., as a result of interference between the incident light 40a to the layer to be etched, and the reflected light 50a on the boundary 34. The detector in the light source detector section 14 receives the reflected light 50, and to the control section, outputs an electric signal being a conversion result of the received reflected light 50. The control section observes, i.e., monitors, the electric signal coming from the detector, and calculates the etching speed from the frequency of the interfered light found in the reflected light 50. In this manner, the etching depth is measured.

The issue here is that the etching method of the related technology is using an etching stop layer. The use of an etching stop layer has several drawbacks of imposing restrictions on the chemical solutions, the etching gas, and the etching requirements, complicating the process, and causing variations to the etching amount except for the etching depth, for example. The use of the etching stop layer also adds constraints to the device designing, whereby it is highly likely to adversely affect the device characteristics.

With the related technologies, the etching speed is calculated from the frequency of an interfered light for use as a calculation basis for the etching depth. This advantageously increases the calculation precision for the etching depth. Such related technologies, however, are using the reflected light on the area covered by the mask, i.e., mask pattern. When the pattern area is small in the mask, the reflected light on the mask pattern will be thus reduced in intensity, and the intensity of the interfered light will not be enough, either.

The method shown in FIGS. 7 and 8, i.e., the method of etching a multilayer etching film varying in index of refraction with the etching depth measured by the interfered light as a result of light reflection on the boundary between the layers to be etched, is not dependent on the use of a mask. Considered here is a case, with the method, of forming a plurality of layers to be etched by crystal growth on a substrate. In this case, the nonuniformity of crystal growth may vary the thickness of the layers to be etched. When the thickness of the layer to be etched reaches the value defined by a specific relational expression for the wavelength of the incident light, the incident light entering the layer to be etched is cancelled out by the light reflected on the surface opposite to the incident-light-receiving surface so that no interfered light is generated. With this being the case, the etching speed cannot be calculated because no interfered light is available for monitoring. The etching depth cannot be thus measured.

### SUMMARY OF THE INVENTION

An object of the invention is to provide an etching method and apparatus that are not dependent on the use of a mask, and are capable of measuring the etching depth even when layers to be etched vary in thickness due to the nonuniformity of crystal growth.

The invention is directed to an etching method for etching a plurality of layers to be etched having a different index of refraction. In the etching method, the layers to be etched are illuminated by two coherent lights each having a different wavelength, and two interfered lights generated by the illuminating two different lights reflected on a boundary between the layers to be etched are observed. Based on the frequency of either of the two observed interfered lights whichever meeting predetermined requirements, the etching depth is measured.

According to the invention, for etching a plurality of layers to be etched varying in index of refraction, the layers to be etched are illuminated by two coherent lights each having a different wavelength, and two interfered lights generated by the illuminating two different lights reflected on a boundary between the layers to be etched are observed. Based on the frequency of either of the two observed interfered lights whichever meeting the predetermined requirements, the etching depth is measured.

As such, the layers to be etched are illuminated by two lights each having a different wavelength, and two interfered lights generated by light reflection on a boundary between the layers to be etched are observed. Based on the frequency of either of the two observed interfered lights whichever meeting the predetermined requirements, the etching depth is measured. Accordingly, even when one of the interfered lights is not observed, the remaining interfered light is available for observation. This thus enables to measure the etching depth based on the frequency of the interfered light.

According to the invention, even when one of the two different interfered lights is not observed, the remaining interfered light is available for observation. This thus enables to measure the etching depth based on the frequency of the interfered light. Accordingly, without being dependent on the use of a mask, the etching depth can be measured even when the layers to be etched vary in thickness due to the nonuniformity of crystal growth.

In an aspect of the invention, when the etching depth is measured, the etching speed is calculated from the frequency of the interfered light meeting the predetermined requirements, and based on the calculated etching speed and the time taken for the etching, the etching depth is measured.

According to the invention, the etching speed is calculated from the frequency of the interfered light, and the etching depth is measured based on the calculated etching speed and the time taken for the etching so that the etching depth can be measured with high precision.

According to the invention, the etching depth can be measured with high precision so that the processing precision can be increased for the etching depth.

In another aspect of the invention, of adjacent layers of the plurality of layers to be etched whose boundary has a maximum reflection among those of boundaries of the other adjacent layers of the plurality of layers, a light illumination side layer of the adjacent layers whose boundary has the maximum reflection has an index of refraction lower than that of the other of the adjacent layers to be etched, and at least either of the two different coherent lights has a wavelength λ not satisfying an equation of L÷(λ/n)=N1/4+m, where L denotes a thickness of the light illumination side layer to be etched, n denotes the index of refraction thereof, m is a natural number, and N1 is 1 or 3.

According to the invention, the wavelength of either of the two different lights is set not to equalize a value of adding m to 1/4 or 3/4 to a value derived by dividing the thickness L of the layer to be etched by the wavelength λ/n in the layer to be etched. This prevents the incident light and the reflected light from canceling out each other while the thickness L shows no change.

According to the invention, while the thickness L shows no change, the incident light and the reflected light do not cancel out each other. This thus enables to always observe at least one interfered light so that the etching depth can be measured.

In still another aspect of the invention, the two different coherent lights each have a wavelength equivalent to the band gap energy of the layer to be etched, or the wavelength in a close range thereof.

According to the invention, the two different coherent lights each have a wavelength equivalent to the band gap energy of the layer to be etched, or the wavelength in a close range thereof. The reflected light is not thus reduced in light intensity, and no light absorption is observed.

According to the invention, because the reflected light is not reduced in light intensity, and no light absorption is observed, the interfered light can be available for observation so that the etching depth can be measured from the frequency of the interfered light.

The invention is also directed to an etching method for etching a plurality of layers to be etched varying in index of refraction. In the method, the layers to be etched are illuminated by coherent lights of the same wavelength coming from two different directions. Two interfered lights generated by the illuminating lights coming from the two different directions and being reflected on a boundary between the layers to be etched are observed. Based on the frequency of either of the two observed interfered lights whichever meeting predetermined requirements, the etching depth is measured.

According to the invention, for etching a plurality of layers to be etched varying in index of refraction, the layers to be etched are illuminated by coherent lights of the same wavelength coming from two different directions, and two interfered lights generated by the illuminating lights coming from the two different directions and being reflected on the boundary between the layers to be etched are observed. Based on the frequency of either of the two observed interfered lights whichever meeting the predetermined requirements, the etching depth is measured.

As such, the layers to be etched are illuminated from two different directions by the lights of the same wavelength, and two interfered lights generated by the reflected lights reflected on the boundary between the layers to be etched are observed. Based on the frequency of either of the two observed interfered lights whichever meeting the predetermined requirements, the etching depth is measured. Accordingly, even when one of the interfered lights is not observed, the remaining interfered light is available for observation. This thus enables to measure the etching depth based on the frequency of the interfered light.

According to the invention, even when one of the interfered lights is not observed, the remaining interfered light is available for observation. This thus enables to measure the etching depth based on the frequency of the interfered light. Accordingly, without being dependent on the use of a mask, the etching depth can be measured even when the layers to be etched vary in thickness due to the nonuniformity of crystal growth.

In another aspect of the invention, one of the two different directions is vertical to the surface of the layers to be etched, of adjacent layers of the plurality of layers to be etched whose boundary has a maximum reflection among those of boundaries of the other adjacent layers of the plurality of layers, a light illumination side layer of the adjacent layers whose boundary has the maximum reflection has an index of refraction lower than that of the other of the adjacent layers to be etched, and in the light illumination side layer, an angle θ between a direction vertical to a surface of layers to be etched and a second direction being the other of the two different directions does not satisfy an equation of cos θ=2 nL/(2 nL+λN2), where L denotes a thickness of the light illumination side layer to be etched, n denotes the index of refraction thereof, λ is the wavelength of the coherent lights, and N2 is an odd natural number.

According to the invention, one of the two different directions is vertical to the surface of the layers to be etched, and the remaining direction forms an angle θ not satisfying the equation of cos θ2 nL/.(2 nL+λN2) in the direction vertical to the surface of the layers to be etched. Therefore, the two interfered lights generated by the two reflected lights are not cancelled out at the same time.

According to the invention, the two interfered lights generated by the two reflected lights are not cancelled out at the same time. This thus enables to always observe the interfered light so that the etching depth can be measured from the frequency of the interfered light.

In another aspect of the invention, the predetermined requirements are of being either of the observed interfered lights having the larger amplitude.

According to the invention, the etching depth is measured based on the frequency of either of the two interfered lights whichever meeting the predetermined requirements, e.g., requirements of having the larger amplitude. This precludes the possibility of using the interfered light in which the incident light and the reflected light are cancelled out each other.

According to the invention, there is no possibility of using the interfered light in which the incident light and the reflected light are cancelled out each other so that the interfered light is always available for observation. As such, the etching depth can be measured from the frequency of the interfered light.

The invention is also directed to an etching apparatus for etching a plurality of layers to be etched varying in index of refraction. The etching apparatus includes: a light emission section for emitting two coherent light seach having a different wavelength; an optical system for illuminating the layers to be etched by the two different lights emitted from the light emission section; a detector for receiving two interfered lights generated by the two different lights that illuminate the layers to be etched by the optical system, and that are reflected on a boundary between the layers to be etched; and a measurement section for measuring the etching depth based on the frequency of either of the two interfered lights received by the detector whichever meeting predetermined requirements.

According to the invention, for etching a plurality of layers to be etched varying in index of refraction, the light emission section emits two coherent lights each having a different wavelength. The optical system illuminates the layers to be etched by the two different lights emitted from the light emission section. The detector receives two interfered lights generated by the two different lights that illuminates the layers to be etched by the optical system, and are reflected on the boundary of the layers to be etched. The measurement section measures the etching depth based on the frequency of either of the two interfered lights received by the detector whichever meeting the predetermined requirements.

As such, the layers to be etched are illuminated by two lights each having a different wavelength, and two interfered lights generated by light reflection on the boundary between the layers to be etched are observed. Based on the frequency of either of the two observed interfered lights whichever meeting the predetermined requirements, the etching depth is measured. Accordingly, even when one of the interfered lights is not observed, the remaining interfered light is available for observation. This thus enables to measure the etching depth based on the frequency of the interfered light.

According to the invention, even when one of the two interfered lights is not observed, the remaining interfered light is available for observation. This thus enables to measure the etching depth based on the frequency of the interfered light. Accordingly, without being dependent on the use of a mask, the etching depth can be measured even when the layers to be etched vary in thickness due to the nonuniformity of crystal growth.

The invention is also directed to an etching apparatus for etching a plurality of layers to be etched varying in index of refraction. The etching apparatus includes: a light emission section for emitting coherent lights of the same wavelength; an optical system for illuminating the layers to be etched by the lights emitted from the light emission section from two different directions; a detector for receiving two interfered lights generated by the lights from the two different directions that illuminate the layers to be etched by the optical system, and that are reflected on a boundary between the layers to be etched; and a measurement section for measuring the etching depth based on the frequency of either of the two interfered lights received by the detector whichever meeting predetermined requirements.

According to the invention, for etching a plurality of layers to be etched varying in index of refraction, the light emission section emits coherent lights of the same wavelength. The optical system illuminates the layers to be etched by the lights emitted from the light emission section in two different directions. The detector receives two interfered lights generated by the lights from the two different directions that illuminate the layers to be etched by the optical system, and are reflected on the boundary between the layers to be etched. The measurement section measures the etching depth based on the frequency of either of the two interfered lights received by the detector whichever meeting the predetermined requirements.

As such, the layers to be etched are illuminated by the lights of the same wavelength from two different directions, and two interfered lights generated by light reflection on the boundary between the layers to be etched are observed. Based on the frequency of either of the two observed interfered lights whichever meeting the predetermined requirements, the etching depth is measured. Accordingly, even when one of the interfered lights is not observed, the remaining interfered light is available for observation. This thus enables to measure the etching depth based on the frequency of the interfered light.

According to the invention, even when one of the two interfered lights is not observed, the remaining interfered light is available for observation. This thus enables to measure the etching depth based on the frequency of the interfered light. Accordingly, without being dependent on the use of a mask, the etching depth can be measured even when the layers to be etched vary in thickness due to the nonuniformity of crystal growth.

In another aspect of the invention, the light emission section includes a spectrometer for splitting the light into lights of varying wavelengths.

According to the invention, using the spectrometer, the layers to be etched are illuminated by the two lights of different wavelengths so that the number of light sources can be reduced to one.

According to the invention, the number of light sources can be reduced to one so that the light emission section can be reduced in size.

In still another aspect of the invention, the light emission section includes a light source for emitting a laser light.

According to the invention, the light source in the light emission section can emit laser light so that the light to be emitted therefrom can be aligned in phase.

According to the invention, the light to be emitted is aligned in phase so that the interfered lights can be generated with ease.

In still another aspect of the invention, the etching apparatus further includes a determination section for determining whether the etching depth measured by the measurement section reaches a predetermined etching depth, and a display section for displaying thereon, when the determination section determines that the etching depth reaches the predetermined etching depth, a message telling that the etching depth reaches the predetermined etching depth.

According to the invention, when the measured etching depth reaches the predetermined etching depth, the message is displayed to tell that the etching depth has reached the predetermined etching depth. Accordingly, the operator of the etching apparatus can acknowledge that the etching depth has reached the predetermined etching depth.

According to the invention, the operator of the etching apparatus can acknowledge that the etching depth has reached the desired etching depth so that he or she can stop the etching operation with any desired etching depth.

In still another aspect of the invention, the etching apparatus further includes a determination section for determining whether the etching depth measured by the measurement section reaches a predetermined etching depth, and a stop section for stopping, when the determination section determines that the etching depth reaches the predetermined etching depth, an etching operation for the layer to be etched.

According to the invention, when the etching depth is determined as being the predetermined etching depth, the etching operation is stopped so that the etching operation can be stopped with any desired etching depth.

According to the invention, the etching operation can be stopped with any desired etching depth so that the processing precision can be increased for the etching depth.

### BRIEF DESCRIPTION OF THE DRAWINGS

Other and further objects, features, and advantages of the invention will be more explicit from the following detailed description taken with reference to the drawings wherein:

FIG. 1 is a schematic diagram showing an etching apparatus according to an embodiment of the invention;

FIGS. 2A and 2B are both a diagram for illustrating interference in a layer to be etched between an incident light and a reflected light;

FIGS. 3A and 3B are both a diagram showing the waveform to be observed by a light source detector section shown in FIG. 1;

FIG. 4 is a schematic diagram showing the configuration of an etching apparatus according to another embodiment of the invention;

FIG. 5 is a diagram for illustrating the direction of the incident light shown in FIG. 4;

FIG. 6 is a flowchart showing the process procedure of an etching method according to still another embodiment of the invention;

FIG. 7 is a schematic diagram showing the configuration of an etching apparatus of a related technology; and

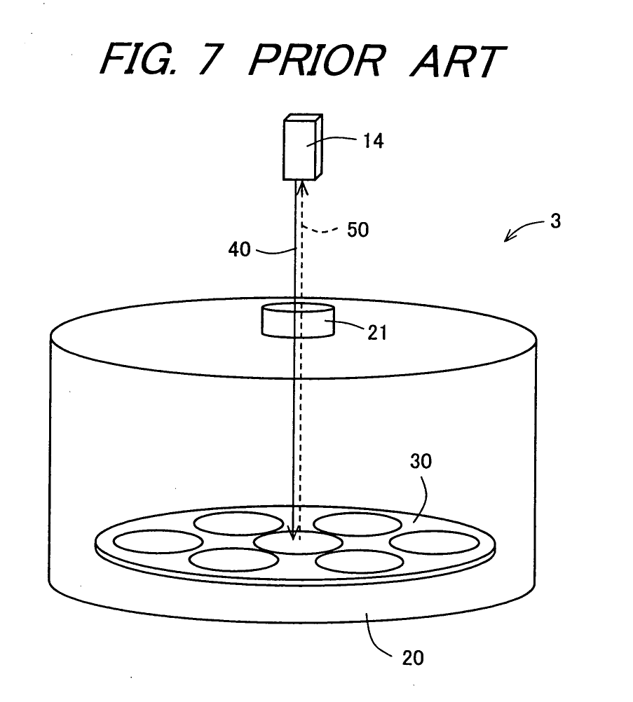

FIG. 8 is a diagram showing the cross section of a to-be-etched substrate shown in FIG. 7.

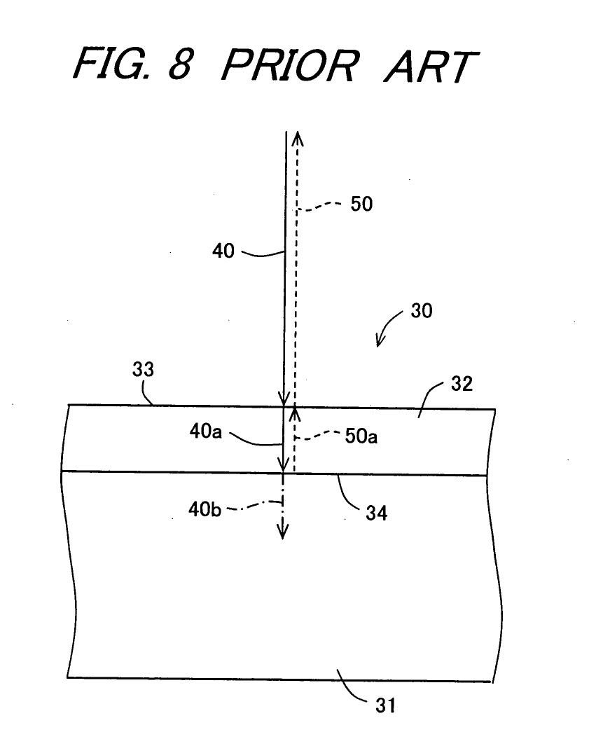

### DETAILED DESCRIPTION

Now referring to the drawings, preferred embodiments of the invention are described below.

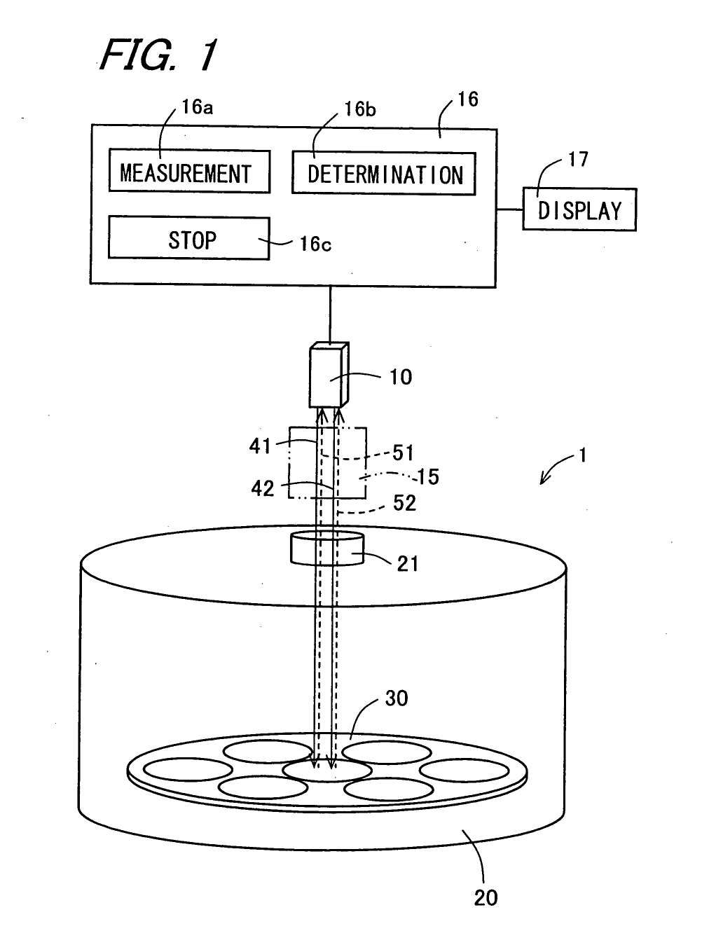

FIG. 1 is a schematic diagram showing the configuration of an etching apparatus 1 according to an embodiment of the invention. The etching apparatus 1 includes a light source detector section 10, a dry etching chamber 20, an optical system 15, and a control section 16. The light source detector section 10 includes a light source for emitting light, and a detector for receiving the light emitted from the light source and reflected on a to-be-etched substrate 30 which is an etching object. The dry etching chamber 20 is a chamber for dry-etching the to-be-etched substrate 30 disposed therein. The optical system 15 guides the light emitted from the light source to the to-be-etched substrate 30. The control section 16 is electrically connected to the light source detector section 10, and receives signals from the detector. The control section 16 calculates the etching depth based on the frequency of an interfered light found in the reflected light received by the detector in the light source detector section 10. When the calculated etching depth reaches a predetermined etching depth, the etching operation is stopped.

The light source in the light source detector section 10 is configured by two light sources that emit laser lights of varying wavelengths, for example. These light sources configure a light emission section, and emit lights of two different wavelengths. The optical system 15 is configured by a lens, a mirror, and a prism, for example. The dry etching chamber 20 is provided for dry etching with respect to the to-be-etched substrate 30 disposed therein. The dry etching chamber 20 is provided with a light transmitting window 21 that passes therethrough the light coming from the light source, and illuminates the to-be-etched substrate 30 by the light therethrough.

The two lights of different wavelengths emitted from the light source in the light source detector section 10, i.e., incident lights 41 and 42, pass through the light transmitting window 21 of the dry etching chamber 20 via the optical system 15, and illuminate the to-be-etched substrate 30. The two incident lights 41 and 42 of different wavelengths illuminating the to-be-etched substrate 30 are reflected on the to-be-etched substrate 30. The resulting lights reflected on the to-be-etched substrate 30, i.e., reflected lights 51 and 52, pass through the light transmitting window 21, and proceed in the direction of the light source detector section 10.

The to-be-etched substrate 30 includes a multilayer etching film, which is configured by a plurality of layers to be etched formed on the substrate. The reflected lights 51 and 52 as a result of light reflection on the to-be-etched substrate 30 each include an interfered light as a result of light reflection on the surface of the layers to be etched and on the boundary between the layers to be etched. The detector in the light source detector section 10 includes a photoreceptor, for example, and converts, to an electric signal, the intensity of the two reflected lights 51 and 52 received by the photoreceptor. The resulting electric signal is forwarded to the control section 16.

The control section 16 is configured by a measurement section 16a, a determination section 16b, and a stop section 16c. The control section 16 is implemented by a computer, and a control program for exercising control over the computer. The measurement section 16a measures the etching depth based on the frequency of either of the two interfered lights received by the detector, whichever meeting the predetermined requirements. The measurement section 16b determines whether the etching depth measured by the measurement section 16a has reached the predetermined etching depth or not. When the determination section 16b determines that the etching depth has reached the predetermined depth, the stop section 16c responsively stops the etching operation to the layer to be etched. Such components as the. measurement section 16a, the determination section 16b, and the stop section 16c are implemented by a computer, and control programs each for taking charge of function execution.

With such a configuration, in the control section 16, the measurement section 16a observes the electric signal provided by the detector, and calculates the etching speed from the frequency of either of the two interfered lights in the reflected lights 51 and 51, whichever meeting the predetermined requirements, e.g., the interfered light having the larger amplitude. When the two interfered lights have the same amplitude, either of the interfered lights will do. In the control section 16, the measurement section 16a calculates the etching depth based on thus calculated etching speed and the time taken for the etching operation. In the control section 16, the determination section 16b determines whether the calculated etching depth has reached the predetermined etching depth or not. In the control section 16, when the determination section 16b determines that the etching depth has reached the predetermined etching depth, the stop section 16c responsively stops the etching operation.

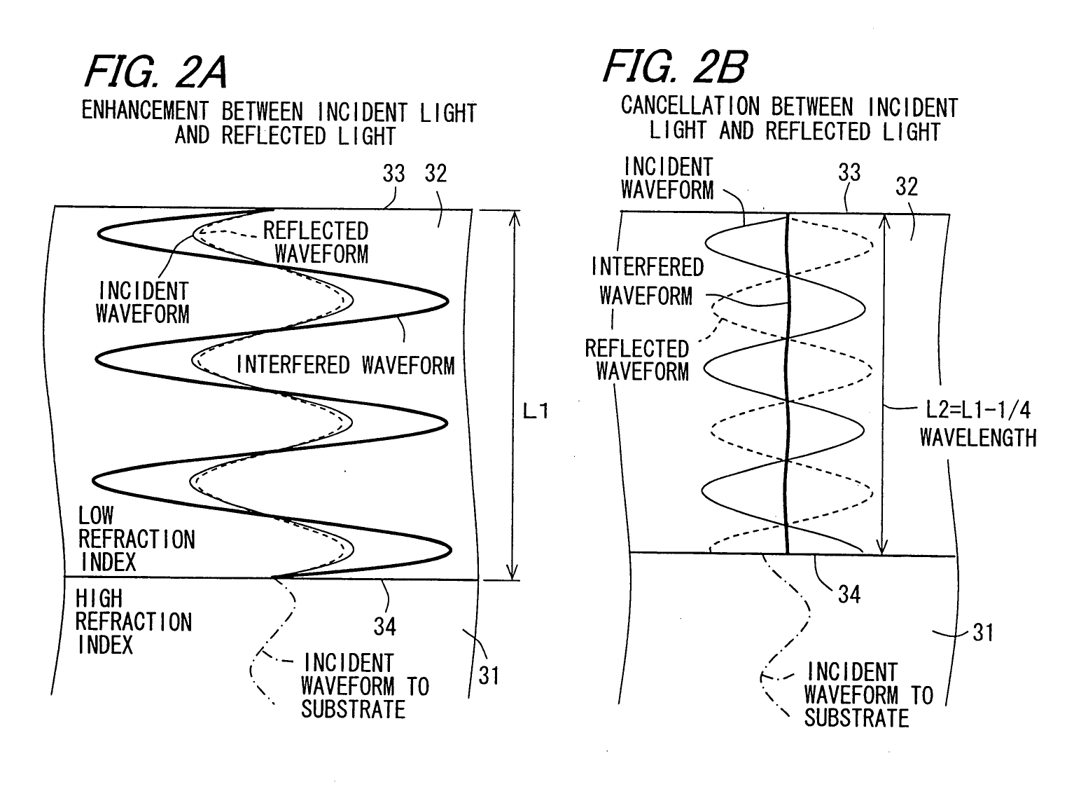

FIGS. 2A and 2B are both a diagram for illustrating the interference between an incident light and a reflected light in the layer to be etched. FIGS. 2A and 2B both show the enlargement view of the to-be-etched substrate 30 shown in FIG. 1, and for the lights of the same wavelength, show the waveforms of the incident light, the reflected light, and the interfered light in the layer to be etched 32. FIGS. 2A and 2B both show a case where the index of refraction of the layer to be etched 32 is lower than that of the substrate 31. The reflected light as a result of light reflection on the boundary 34 with the substrate 31 after passing through the layer to be etched 32 shows a phase change of n. This is because the index of refraction of the substrate 31 is higher than that of the layer to be etched 32. With this being the case, the boundary 34 of the substrate 31 is dealt as a boundary between the layers to be etched.

FIG. 2A shows the interfered waveform when the light enhancement is observed between the incident light and the reflected light. When the thickness L1 of the layer to be etched 32 is equal in value to a multiple of one half of the wavelength of the incident light in the layer to be etched, such light enhancement is observed between the incident light and the reflected light. That is, after reflected on the boundary 34, the incident light passing through the layer to be etched 32 is shifted in phase by n so that, in the waveform, the incident light shares the same phase as the reflected light. Accordingly, in the interfered waveform, the incident light and the reflected light are enhanced each other. The incident light partially passes through the boundary 34 so that the reflected waveform will show the amplitude slightly smaller than that of the incident waveform. In FIG. 2A, the thickness L1 of the layer to be etched 32 is three times thicker than the wavelength of the incident light in the layer to be etched 32.

FIG. 2B shows the interfered waveform when the incident light and the reflected light are cancelled out each other. When the thickness L2 of the layer to be etched 32 is equal to the thickness, i.e., a value derived by adding a 1/4 wavelength or 3/4 wavelength to a multiple of the wavelength of the incident light in the layer to be etched 32, the incident light and the reflected light are cancelled out each other. That is, the incident light passing through the layer to be etched 32 will be shifted in phase by n when reflected on the boundary 34 so that the phase of the reflected waveform will be opposite to the phase of the incident waveform. Accordingly, the interfered waveform shows the result of the incident waveform and the reflected waveform being cancelled out each other. Because the incident light partially passes through the boundary 34, the reflected waveform will be slightly smaller in amplitude than the incident waveform. Although the interfered waveform will have a slight amplitude, this is considered not enough for observation. FIG. 2B shows an exemplary case where the layer to be etched 32 is etched by the thickness corresponding to the 1/4 wavelength, and the thickness L2 of the layer to be etched 32 is thinned from the thickness L1 by the thickness corresponding to the 1/4 wavelength.

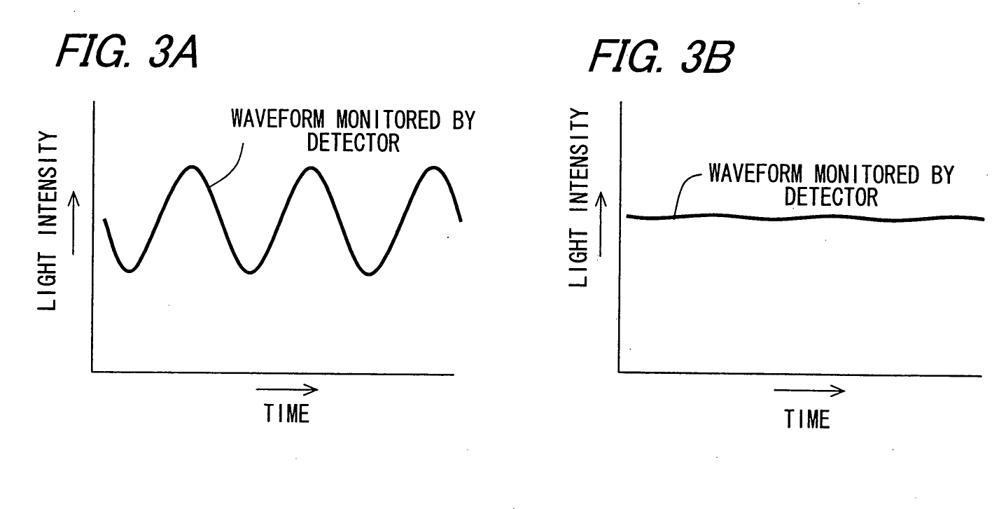

FIGS. 3A and 3B both show a waveform to be observed by the light source detector section 10 shown in FIG. 1. More specifically, FIG. 3A shows the waveform in which the reflected light is observed, i.e., monitored, when the incident and reflected lights shown in FIG. 2A are enhanced each other. In FIG. 3A, the vertical axis indicates the light intensity, and the lateral axis indicates the time. In the waveform to be observed, the light reflected on the etching surface 33 is overlaid with the interfered light generated inside of the layer to be etched 32. Such waveform of the interfered light tells the frequency of the interfered light, and the frequency is used as a basis to calculate the etching speed.

FIG. 3B shows the waveform in which the reflected light is monitored, in which the incident and reflected lights shown in FIG. 2B are cancelled out each other. In FIG. 3B, the vertical axis indicates the light intensity, and the lateral axis indicates the time. In the waveform, the amplitude of the interfered light in the reflected light is hardly observed, and observed is only the intensity of the reflected light on the etching surface 33. With this being the case, because the frequency of the interfered light cannot be observed, the etching speed cannot be calculated.

That is, every time the thickness of the layer to be etched 32 shows a change by a value corresponding to the 1/4 wavelength of the incident light in the layer to be etched, the incident light and the reflected light are enhanced or cancelled out each other. The amplitude of the interfered light is thus repeatedly increased or decreased.

FIGS. 2A, 2B, 3A, and 3B are showing the interfered lights of the same wavelength. The etching apparatus 1 shown in FIG. 1 directs the two lights of different wavelengths to the layer to be etched 32 for illumination thereof. When no interfered waveform is observed for the lights of the same wavelength, it is possible to observe the interfered waveform of lights of other wavelengths. This thus allows to calculate the etching speed from the interfered waveform observed for the lights of other wavelengths so that the etching depth can be measured.

As such, the layers to be etched are illuminated by two lights of different wavelengths, and two interfered lights generated by light reflection on a boundary between the layers to be etched are observed. Based on the frequency of either of the two observed interfered lights whichever meeting the predetermined requirements, the etching depth is measured. Accordingly, even when one of the interfered lights is not observed, the remaining interfered light is available for observation. This thus enables to measure the etching depth based on the frequency of the interfered light. As such, without being dependent on the use of a mask, the etching depth can be measured even when the layers to be etched vary in thickness due to the nonuniformity of crystal growth.

Considered here is a case where the wavelength of the lights for use to measure the etching depth is considerably different from the wavelength corresponding to the band gap energy of the layer to be etched. In this case, the reflected light is reduced in intensity or observed with light absorption. Accordingly, it is desirable that the two lights coming from the light source of the light source detector section 10 each have the wavelength equivalent to the band gap energy or the wavelength in a close range thereof. The range will be of about ±100 nm with respect to the wavelength equivalent to the band gap energy.

As such, two interfered wavelengths are changed to be equivalent to the band gap energy of the layer to be etched or be in a close range thereof so that the reflected light is not reduced in intensity or no light absorption is observed. This thus enables to observe the interfered light so that the etching depth can be measured from the frequency of the interfered light.

Either of the different wavelengths of the lights is required not to cause the incident light and the reflected light to cancel out each other with respect to the thickness of the layers to be etched. In consideration thereof, the wavelength λ of at least either of the two lights coming from the light source detector section 10 is required not to satisfy the equation of L÷(λ/n)=N1/4+m. Of adjacent layers of the plurality of layers to be etched whose boundary has a maximum reflection among those of boundaries of the other adjacent layers of the plurality of layers, a light illumination side layer of the adjacent layers whose boundary has the maximum reflection has an index of refraction lower than that of the other of the adjacent layers to be etched. In the equation, L denotes the thickness of the light illumination side layer to be etched, n denotes the index of refraction thereof, m is a natural number, and N1 is either 1 or 3. That is, the thickness L of the layer to be etched is required not to satisfy the value derived by adding a 1/4 or 3/4 wavelength to m of the wavelength λ/n in the layer to be etched. The reflectance of the boundary takes a value indicating the ratio of the reflected light to the incident light, e.g., a value derived by dividing the amount of the reflected light reflected on the boundary by the amount of the incident light.

As such, the wavelength of either of the two different lights is set not to equalize a value of adding m to 1/4 or 3/4 to a value derived by dividing the thickness L of the layer to be etched by the wavelength λ/n in the layer to be etched. This prevents the incident light and the reflected light from canceling out each other while the thickness L shows no change. This thus enables to always observe at least one interfered light so that the etching depth can be measured.

Described next is an exemplary case where the embodiment shown in FIG. 1 is applied to a wafer, i.e., to-be-etched substrate, in which a GaAs (gallium arsenide) semiconductor substrate is formed thereon with AlGaInP (aluminum gallium indium phosphide) layers by crystal growth. These two AlGaInP layers have each different composition ratio, and in the below, the AlGaInP layer formed on the GaAs semiconductor substrate is referred to as AlGaInP layer 1, and the AlGaInP layer formed on the AlGaInP layer 1 is referred to as AlGaInP layer 2.

The AlGaInP layer 1 is designed to have the thickness of 1.000 μm, and the index of refraction of 3.2. Such an AlGaInP layer is dry-etched by being exposed to a laser light 1 having a wavelength of 670 nm, and a laser light 2 having a wavelength of 637 nm. The wavelength of the laser light 1 will be 209.4 nm in the AlGaInP layer 1, dividing the wavelength 670 nm of the laser light 1 by the index of refraction. The wavelength of the laser light 2 will be 199.1 nm in the AlGaInP layer 1, similarly dividing the wavelength by the index of refraction. The 1/4 wavelengths at this time are 52.35 nm and 49.77 nm, respectively. The index of refraction of the substrate 31 is higher than that of the AlGaInP layer 1.

In the AlGaInP layer 1, when the thickness of the AlGaInP layer 1 is 1.047 μm, the interfered light is generated as a result of light enhancement between the incident light in the AlGaInP layer 1 and the light reflected on the boundary between the AlGaInP layer 1 and the GaAs semiconductor substrate. That is, the interfered light is generated when the thickness of the AlGaInP layer 1 is a multiple of the 1/2 wavelength of the laser light 1 in the AlGaInP layer 1. In this example, the thickness of the AlGaInP layer 1 takes a value five times the wavelength of the laser light 1 in the AlGaInP layer 1. When the thickness of the AlGaInP layer 1 is 0.995 μm, the incident light and the reflected light are cancelled out each other, i.e., when the thickness takes a value derived by adding the 1/4 or 3/4 wavelength to the multiple of the wavelength of the laser light 1 in the AlGaInP layer 1. In this example, the thickness of the AlGaInP layer 1 is a value derived by adding the 3/4 wavelength to the value four times the wavelength of the laser light 1 in the AlGaInP layer 1.

In consideration of nonuniformity of crystal growth, the layer thickness, i.e., 1.047 μm and 0.995 μm are in the possible range for the design value of 1.000 μm. When the AlGaInP layer 1 has the thickness of 0.995 μm, the interfered light by the laser light 1 becomes small in amplitude, and becomes not available for observation. The interfered light by the laser light 2 will have the thickness enhancing the incident light and the reflected light so that the interfered light becomes available for observation. In this example, the thickness of the AlGaInP layer 1 takes a value five times the wavelength of the laser light 2 in the AlGaInP layer 1.

By appropriately selecting the wavelength for the two laser lights as such, even when one of the interfered lights is reduced in amplitude by the laser light, the amplitude of the remaining interfered light remains the same even when with the laser light so that the etching depth can be measured using the interfered light having the larger amplitude.

In the above embodiment, the to-be-etched substrate 30 is illuminated by the two lights each having a different wavelength using two light sources emitting lights of varying wavelengths. Alternatively, the optical system may be additionally provided with a spectrometer using a half mirror or others, and this spectrometer may split a light coming from a single light source into two lights of different wavelengths for illumination of the to-be-etched substrate 30. With this being the configuration, the light source and the spectrometer configure a light emission section.

As such, using the spectrometer, two lights of different wavelengths illuminate the to-be-etched substrate 30, especially the layer to be etched, so that the number of light sources can be reduced to one. With such a configuration, the light emission section can be accordingly reduced in size.

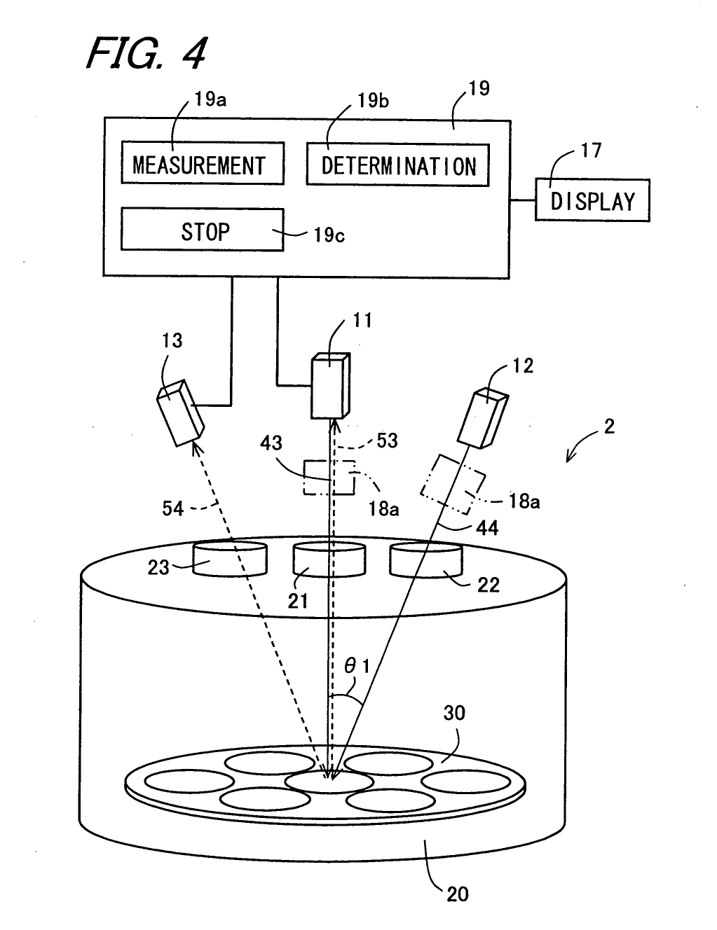

FIG. 4 is a schematic diagram showing the configuration of an etching apparatus 2 according to another embodiment of the invention. The etching apparatus 2 includes a light source detector section 11, a light source section 12, a detector section 13, a dry etching chamber 20, optical systems 18a and 18b, and a control section 19. The light source detector section 11 includes a light source that emits a light, i.e., incident light 43, and a detector for receiving the incident light 43 reflected on the to-be-etched substrate 30 being an etching object, i.e., reflected light 53. The light source section 12 is provided with a light source for emitting a light, i.e., incident light 44 having the same wavelength as a light coming from the light source in the light source detector section 11. The detector section 13 is provided with a detector that receives the incident light 44 reflected on the to-be-etched substrate 30, i.e., reflected light 54. The dry etching chamber 20 is provided to dry-etch the to-be-etched substrate 30 disposed therein. The optical systems 18a and 18b guide, to the to-be-etched substrate 30, the incident light 43 emitted from the light source in the light source detector section 11, and the incident light 44 emitted from the light source in the light source section 12. The control section 19 is electrically connected to the light source detector section 11 and the detector section 13. The control section 19 receives signals from the respective detectors, and calculates the etching depth based on the frequency of the interfered light found in the reflected light 53 received by the detector in the light source detector section 11, or in the reflected light 54 received by the detector in the detector section 13. Based on thus calculated etching depth, the etching operation is stopped.

The light source in the light source detector section 11 and the light source in the light source section 12 are each configured by a light source emitting laser light or others, and serve as a light emission section. The incident light 43 coming from the light source in the light source detector section 11 shares the same wavelength with the incident light 44 coming from the light source in the light source section 12. The optical systems 18a and 18b are each configured by a lens, a mirror, and a prism, for example.

The dry etching chamber 20 is provided to apply an etching operation to the to-be-etched substrate 30 disposed therein. The dry etching chamber 20 includes a first light transmitting window 21, a second light transmitting window 22, and a third light transmitting window 23. The first light transmitting window 21 passes therethrough the incident light 43 coming from the light source in the light source detector section 11, and the incident light 43 illuminates the to-be-etched substrate 30. The second light transmitting window 22 passes therethrough the incident light 44 coming from the light source in the light source section 12, and the incident light 44 illuminates the to-be-etched substrate 30. The third light transmitting window 23 passes therethrough the light as a result of reflection, on the to-be-etched substrate 30, of the incident light 44 coming from the light source section 12, and the resulting reflected light 54 is guided to the detector section 13.

The incident light 43 coming from the light source in the light source detector section 11 passes through the first light transmitting window 21 of the dry etching chamber 20 via the optical system 18a. The resulting incident light 43 illuminates the to-be-etched substrate 30. The incident light 43 illuminating the to-be-etched substrate 30 as such is reflected on the to-be-etched substrate 30, and the resulting reflected light 53 passes through the first light transmitting window 21. The reflected light 53 is then guided in the direction of the light source detector section 11. That is, the incident light 43 coming from the light source in the light source detector section 11 illuminates the to-be-etched substrate 30 from the direction vertical to the surface of the to-be-etched substrate 30.

The incident light 44 coming from the light source in the light source section 12 passes through the second light transmitting window 22 via the optical system 18b, and the incident light 44 illuminates the to-be-etched substrate 30. The incident light 44 illuminating the to-be-etched substrate 30 is reflected thereon. The reflected light 54 as a result of reflection on the to-be-etched substrate 30 passes through the third light transmitting window 23, and is directed to the direction of the detector section 13. The incident light 44 coming from the light source in the light source section 12 illuminates the to-be-etched substrate 30 from the direction of a predetermined angle, e.g., θ1, with respect to the direction vertical to the surface of the to-be-etched substrate 30.

The to-be-etched substrate 30 includes a multilayer etching film configured by a plurality of layers to be etched formed on the substrate. The two lights as a result of light reflection on the to-be-etched substrate 30, i.e., reflected lights 53 and 54, each include an interfered light generated by the light reflected on the surface of the layers to be etched, and on the boundary between the layers to be etched. The detector in the light source detector section 11, and the detector in the detector section 13 are each provided with a photoreceptor. The intensity of the reflected light received by the photoreceptors is converted into an electric signal for output to the control section.

The control section 19 is configured by a measurement section 19a, a determination section 19b, and a stop section 19c. The control section 19 is implemented by a computer, and a control program for exercising control over the computer. The measurement section 19a measures the etching depth based on the frequency of either of the two interfered lights whichever meeting the predetermined requirements. The two interfered lights here are those received by the detector in the light source detector section 11 and the detector in the detector section 13. The determination section 19b determines whether the etching depth measured by the measurement section 19a has reached the predetermined etching depth or not. When the determination section 19b determines that the etching depth has reached the predetermined depth, the stop section 19c responsively stops the etching operation to the layers to be etched. Such components as the measurement section 19a, the determination section 19b, and the control section 19c are implemented by a computer, and control programs each for taking charge of the corresponding function execution.

With such a configuration, in the control section 19, the measurement section 19a observes the electric signals provided by the detector in the light source detector section 11 and the detector in the detector section 13. The control section 19 then calculates the etching speed from the frequency of either of the two interfered lights in the reflected lights 53 and 54, whichever meeting the predetermined requirements, e.g., the interfered light having the larger amplitude. When the two interfered lights have the same amplitude, either of the interfered lights will do. In the control section 19, the measurement section 19a calculates the etching depth based on thus calculated etching speed and the time taken for the etching operation. In the control section 19, the determination section 19b determines whether the calculated etching depth has reached the predetermined etching depth or not. In the control section 19, when the determination section 19b determines that the etching depth has reached the predetermined etching depth, the stop section 19c responsively stops the etching operation.

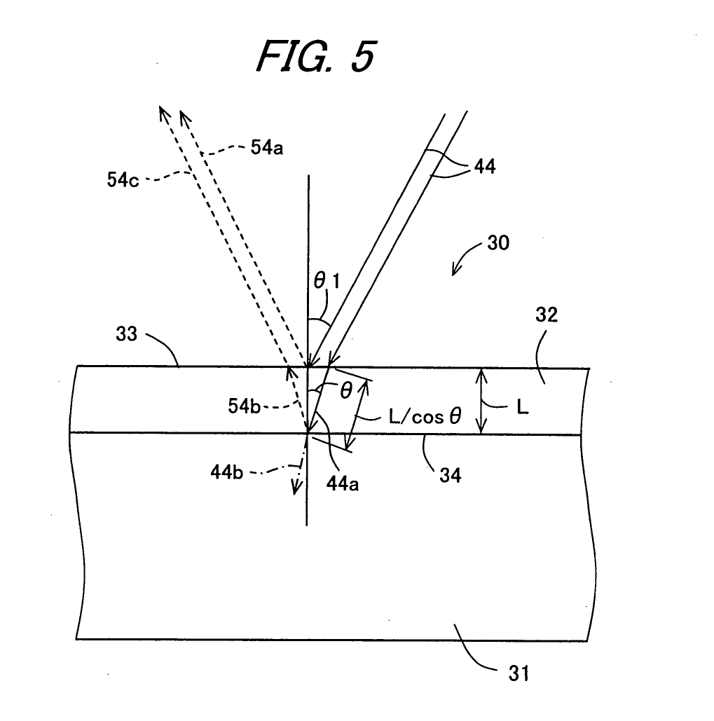

FIG. 5 is a diagram for illustrating the direction of the incident light 44 shown in FIG. 4. The incident light 44 is directed in the direction vertical to the surface of the layer to be etched 32, i.e., the etching surface 33, with the incident angle of θ1. The reflected light 54a is the light as a result of reflection of a part of the incident light 44 on the etching surface 33. The remaining portion of the incident light 44 passes through the etching surface 33, and is directed to the layer to be etched as an incident light 44a.

The incident light 44a directed to the layer to be etched is mostly reflected on the boundary 34 between the layer to be etched 32 and the substrate 31, and the resulting light is a reflected light 54b. The remaining portion of the incident light 44a passes through the boundary 34, and is directed to the substrate as a incident light 44b. Assuming that the layer to be etched 32 has the index of refraction of n, the following relationship is established between the incident angle θ1 of the incident light 44 and the angle θ in the direction vertical to the boundary 34 of the incident light 44a, i.e., the direction vertical to the etching surface 33.
sin θ1=n*sin θ

For the interfered light in the reflected light 53 of the incident light 43 and the interfered light in the reflected light 54 in the incident light 44 not to cause the incident light and the reflected light to cancel out each other in the layers to be etched, the angle θ of the incident light 44a directed to the layer to be etched in the direction vertical to the etching surface 33 does not satisfy the following equation.
cos θ=2 nL/(2 nL+λN2)

Of adjacent layers of the plurality of layers to be etched whose boundary has a maximum reflection among those of boundaries of the other adjacent layers of the plurality of layers, a light illumination side layer of the adjacent layers whose boundary has the maximum reflection has an index of refraction lower than that of the other of the adjacent layers to be etched. In the equation, L denotes the thickness of the light illumination side layer to be etched, e.g., the thickness of the layer to be etched 32 of FIG. 5, n denotes the refraction ratio of the layer to be etched 32, λ denotes the wavelengths of the incident lights 43 and 44, and N2 denotes an odd natural number. That is, a value setting is so made that a value being a difference between the thickness L of the layer to be etched 32 and a distance L/cos θ is not equal to a value derived by multiplying an odd natural number to a 1/2 wavelength of the wavelength λ/n of the incident light 44a directed to the layer to be etched. Herein, the distance L/cos θ indicates a distance that the incident light 44a travels to pass through the layer to be etched 32.

As such, the layers to be etched are illuminated by the lights of the same wavelength from two different directions, and two interfered lights generated by the lights reflected on the boundary between the layers to be etched are observed. Based on the frequency of either of the two observed interfered lights whichever meeting the predetermined requirements, the etching depth is measured. Accordingly, even when one of the interfered lights is not observed, the remaining interfered light is available for observation. This thus enables to measure the etching depth based on the frequency of the available interfered light. Accordingly, without being dependent on the use of a mask, the etching depth can be measured even when the layers to be etched vary in thickness due to nonuniformity of crystal growth.

One of the two different directions is vertical to the surface of the layers to be etched, and the remaining direction forms an angle θ not satisfying the equation of cos θ=2 nL/(2 nL+λN2) in the direction vertical to the surface of the layers to be etched. Therefore, the two interfered lights generated by the two reflected lights are not cancelled out at the same time. This thus enables to always observe the interfered light so that the etching depth can be measured from the frequency of the interfered light.

Described next is an exemplary case where the embodiment shown in FIG. 4 is applied to a wafer, i.e., to-be-etched substrate, in which a GaAs semiconductor substrate is formed thereon with two AlGaInP layers of varying composition ratios by crystal growth. In the below, the AlGaInP layer formed on the GaAs semiconductor substrate is referred to as AlGaInP layer 1, and the AlGaInP layer formed on the AlGaInP layer 1 is referred to as AlGaInP layer 2.

The AlGaInP layer 1 is designed to have the thickness of 1.000 μm, and the index of refraction of 3.2. The laser light of a wavelength of 670 nm coming from the light source is split into two lights using a half mirror and an optical fiber. One of the two lights illuminates the to-be-etched substrate from the direction vertical to the surface thereof, and the other light illuminates the to-be-etched substrate in the AlGaInP layer 1 from the direction with an angle of 18 degrees to the direction vertical to the surface of the to-be-etched substrate. Through such illumination, two AlGaInP layers are subjected to dry etching. The refraction ratio of the substrate 31 is larger than that of the AlGaInP layer 1. In this case, the light source, the half mirror, and the optical fiber configure a light emission section. This light source is corresponding to the light source in the light source detector section 11, and the half mirror and the optical fiber are corresponding to the light source section 12.

Considered here is a case where the laser light is directed from the direction vertical to the surface of the to-be-etched substrate in the AlGaInP layer 1. When the thickness of the AlGaInP layer 1 is 1.047 μm, the interfered light is generated as a result of light enhancement between the incident light in the AlGaInP layer 1 and the light reflected on the boundary between the AlGaInP layer 1 and the GaAs semiconductor substrate. That is, the interfered light is generated when the thickness of the AlGaInP layer is a multiple of the ½ wavelength of the laser light in the AlGaInP layer 1. When the thickness of the AlGaInP layer 1 is 0.995 μm, the incident light and the reflected light are cancelled out each other, i.e., when the thickness takes a value derived by adding the 1/4 or 3/4 wavelength to the multiple of the wavelength of the laser light in the AlGaInP layer 1.

When the thickness of the AlGaInP layer 1 is 0.995 μm, the interfered light by the laser light illuminating from the direction vertical to the surface of the to-be-etched substrate is reduced in amplitude, and thus becomes hardly observed. However, with the interfered light by the laser light coming from another direction, the to-be-etched substrate is illuminated in the AlGaInP layer 1 from the direction with an angle of 18.2 degrees to the vertical direction to the surface thereof. Accordingly, the distance for the incident light to the AlGaInP layer 1 to cover from the etching surface 33 to the boundary 34 elongates by 52.6 nm compared with the thickness of the AlGaInP layer 1. That is, the distance that the laser light directed from the direction with an angle of 18.2 degrees travels in the AlGaInP layer 1 from the etching surface 33 to the boundary 34 will be longer by about ¼ wavelength than the distance that the laser light coming from the direction vertical to the to-be-etched substrate travels in the AlGaInP layer 1. This thus leads to light enhancement between the incident and reflected lights.

As such, by appropriately adjusting the angle difference between the two laser lights coming from each different direction for illumination, even when the interfered light by one of the laser lights is low in intensity, the interfered light by the remaining laser light can remain high. Either of the interfered lights is thus always available so that the etching depth never failed to be measured.

In the above embodiment, using the two light sources, the to-be-etched substrate 30 is illuminated by lights of the same wavelength from different directions. Alternatively, the optical system may be additionally provided with a spectrometer using a half mirror or others, and the light from a light source may be split by the spectrometer so that the resulting lights may illuminate the to-be-etched substrate 30 from various directions. With this being the case, the light source and the spectrometer configure a light emission section.

As such, using the spectrometer, the to-be-etched substrate 30, especially the layer to be etched, is illuminated by lights of the same wavelength from two different directions. This reduces the number of the light sources to one, and the light emission section can be accordingly reduced in size.

In the embodiments described above, the light source in the light emission section emits laser light so that the light coming therefrom can be aligned in phase. Accordingly, the interfered lights can be generated with ease.

The measurement sections 16a and 19a calculate the etching speed based on the frequency of the interfered light, and measure the etching depth from the calculated etching speed and the time taken for the etching operation so that the etching depth can be measured with high precision. Accordingly, the processing precision can be increased for the etching depth.

The measurement sections 16a and 19a measure the etching depth based on the frequency of either of the two interfered lights whichever meeting the predetermined requirement, e.g., the interfered light having the larger amplitude. This accordingly precludes the possibility of using the interfered light in which the incident light and the reflected light are cancelled out each other. This enables to always observe the interfered light so that the etching depth can be measured based on the frequency of the interfered light.

When the determination sections 16b and 19b determine that the etching depth has reached the predetermined etching depth, the stop sections 16c and 19c responsively stop the etching operation so that the etching operation can be stopped with any desired etching depth. This thus increases the processing precision for the etching depth.

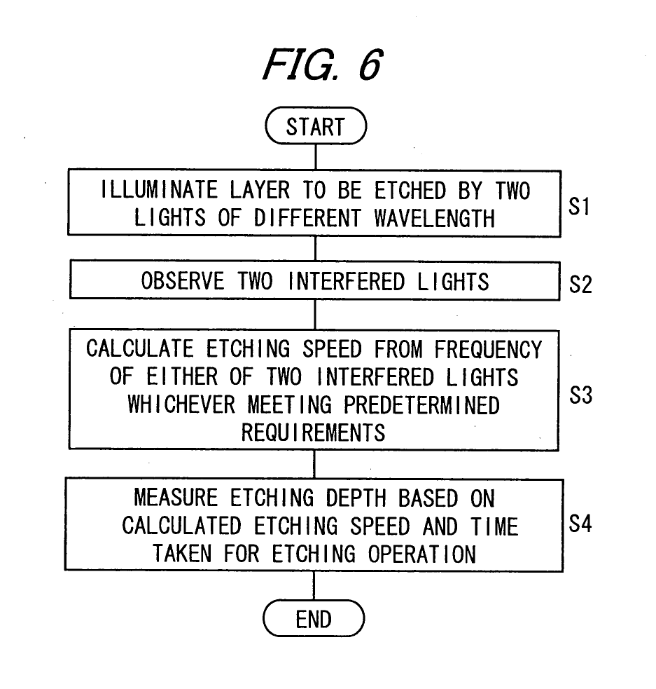

FIG. 6 is a flowchart showing the processing procedure of an etching method according to still another embodiment of the invention. This flowchart shows the processes for the etching apparatus 1 shown in FIG. 1. When the etching apparatus 1 starts an etching operation to the to-be-etched substrate 30, the procedure goes to step S1.

In step S1, the layer to be etched is illuminated using two lights having each different wavelength. The lights having each different wavelength illuminating the layer to be etched are both reflected on the surface of the layer to be etched, and the boundary of the layers to be etched. The resulting two reflected lights each include an interfered light generated by the incident light to the layer to be etched, and the reflected light as a result of reflection on the boundary with the adjacent layer to be etched having the higher index of refraction, or with the substrate.

In step S2, the two interfered lights are observed. In step S3, the etching speed is calculated based on the frequency of either of the interfered lights whichever meeting the predetermined requirements, e.g., the interfered light with larger amplitude. In step S4, the etching depth is calculated based on the resulting etching speed and the time taken for the etching operation. This is the end of the operation.

As such, the layer to be etched is illuminated by two lights each having a different wavelength, and two interfered lights generated by the lights reflected on the boundary between the layers to be etched are observed. Based on the frequency of either of the two interfered lights whichever meeting the predetermined requirements, the etching depth is measured. Accordingly, even when one of the interfered lights is not observed, the remaining interfered light is available for observation. This thus enables to measure the etching depth based on the frequency of the interfered light. This thus enables to measure, without being dependent on the use of a mask, the etching depth even when the layers to be etched vary in thickness due to the nonuniformity of crystal growth.

What is more, the etching speed is calculated from the frequency of the interfered light, and the etching depth is measured from the calculated etching speed and the time taken for the etching operation so that the etching depth can be measured with high precision. Accordingly, the processing precision can be increased for the etching depth.

With the flowchart of the etching method shown in FIG. 6, in step S1, the to-be-etched substrate is illuminated by two lights of each different wavelength. Alternatively, for application to the etching apparatus 2 shown in FIG. 4, in step S1, the to-be-etched substrate may be illuminated from two different directions by lights of the same wavelength as alternatives to the two lights each having a different wavelength.

As such, the layer to be etched is illuminated by the lights of the same wavelength from two different directions, and two interfered lights generated by the lights reflected on the boundary between the layers to be etched are observed. Based on the frequency of either of the two interfered lights whichever meeting the predetermined requirements, the etching depth is measured. Accordingly, even when one of the interfered lights is not observed, the remaining interfered light is available for observation. This thus enables to measure the etching depth based on the frequency of the interfered light. This thus enables to measure, without being dependent on the use of a mask, the etching depth even when the layers to be etched vary in thickness due to the nonuniformity of crystal growth.

With the flowchart of the etching method shown in FIG. 6, the etching depth is measured, and the procedure is ended. Alternatively, the etching apparatus 1 or 2 determines whether the measured etching depth has reached the predetermined etching depth. When the determination is made that the etching depth has reached the predetermined etching depth, the etching operation may be stopped.

As such, when the etching depth has reached the predetermined etching depth, the etching operation is responsively stopped so that the etching operation can be stopped with any desired etching depth. Accordingly, the processing precision can be increased for the etching depth.

In the embodiments described above, when the calculated etching depth has reached the predetermined etching depth, the etching operation is stopped. Alternatively, without stopping the etching operation, a message may be displayed on a display section 17, telling that the etching depth has reached the predetermined etching depth. The display section 17 is the one configured by a liquid crystal display or others equipped to the etching apparatus 1 or 2. With this being the configuration, an operator of the etching apparatus 1 or 2 may stop the etching operation after looking at the message displayed on the display section 17.

As such, when the measured etching depth has reached the predetermined etching depth, the message is displayed to tell that the etching depth has reached the predetermined etching depth so that the operator of the etching apparatus can acknowledge that the etching depth is now at his or her desired etching depth. The operator thus can stop the etching operation with his or her desired etching depth.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An etching method for etching a plurality of layers to be etched having a different index of refraction, comprising:
illuminating the layers to be etched by two coherent lights each having a different wavelength;
observing two interfered lights generated by the illuminating two different lights reflected on a boundary between the layers to be etched; and
based on the frequency of either of the two observed interfered lights whichever meeting predetermined requirements, measuring the etching depth.

2. The etching method of claim 1, wherein when the etching depth is measured, the etching speed is calculated from the frequency of the interfered light meeting the predetermined requirements, and based on the calculated etching speed and the time taken for the etching, the etching depth is measured..

3. The etching method of claim 1, wherein of adjacent layers of the plurality of layers to be etched whose boundary has a maximum reflection among those of boundaries of the other adjacent layers of the plurality of layers, a light illumination side layer of the adjacent layers whose boundary has the maximum reflection has an index of refraction lower than that of the other of the adjacent layers to be etched, and at least either of the two different coherent lights has a wavelength λ not satisfying an equation of L÷(λ/n)=N1/4+m,
where L denotes a thickness of the light illumination side layer to be etched, n denotes the index of refraction thereof, m is a natural number, and N1 is 1 or 3.

4. The etching method of claim 1, wherein the two different coherent lights each have a wavelength equivalent to the band gap energy of the layer to be etched, or the wavelength in a close range thereof.

5. The etching method of claim 1, wherein the predetermined requirements are of being either of the observed interfered lights having the larger amplitude.

6. An etching method for etching a plurality of layers to be etched varying in index of refraction, comprising:
illuminating the layers to be etched by coherent lights of the same wavelength coming from two different directions;
observing two interfered lights generated by the illuminating lights coming from the two different directions and being reflected on a boundary between the layers to be etched; and
based on the frequency of either of the two observed interfered lights whichever meeting predetermined requirements, measuring the etching depth.

7. The etching method of 6 wherein, one of the two different directions is vertical to the surface of the layers to be etched,
of adjacent layers of the plurality of layers to be etched whose boundary has a maximum reflection among those of boundaries of the other adjacent layers of the plurality of layers, a light illumination side layer of the adjacent layers whose boundary has the maximum reflection has an index of refraction lower than that of the other of the adjacent layers to be etched, and in the light illumination side layer, an angle θ between a direction vertical to a surface of layers to be etched and a second direction being the other of the two different directions does not satisfy an equation of cos θ=2 nL/(2 nL+λN2),
where L denotes a thickness of the light illumination side layer to be etched, n denotes the index of refraction thereof, λ is the wavelength of the coherent lights, and N2 is an odd natural number.

8. The etching method of claim 6, wherein the predetermined requirements are of being either of the observed interfered lights having the larger amplitude.

9. An etching apparatus for etching a plurality of layers to be etched varying in index of refraction, comprising:
a light emission section for emitting two coherent lightseach having a different wavelength;
an optical system for illuminating the layers to be etched by the two different lights emitted from the light emission section;
a detector for receiving two interfered lights generated by the two different lights that illuminate the layers to be etched by the optical system, and that are reflected on a boundary between the layers to be etched; and
a measurement section for measuring the etching depth based on the frequency of either of the two interfered lights received by the detector whichever meeting predetermined requirements.

10. The etching apparatus of claim 9, wherein the light emission section includes a spectrometer for splitting the light into lights of varying wavelengths.

11. The etching apparatus of claim 9, wherein the light emission section includes a light source for emitting a laser light.

12. The etching apparatus of claim 9, further comprising:
a determination section for determining whether the etching depth measured by the measurement section reaches a predetermined etching depth; and
a display section for displaying thereon, when the determination section determines that the etching depth reaches the predetermined etching depth, a message telling that the etching depth reaches the predetermined etching depth.

13. The etching apparatus of claim 9, further comprising:
a determination section for determining whether the etching depth measured by the measurement section reaches a predetermined etching depth; and
a stop section for stopping, when the determination section determines that the etching depth reaches the predetermined etching depth, an etching operation for the layer to be etched.

14. An etching apparatus for etching a plurality of layers to be etched varying in index of refraction, comprising:
a light emission section for emitting coherent lights of the same wavelength;
an optical system for illuminating the layers to be etched by the lights emitted from the light emission section from two different directions; a detector for receiving two interfered lights generated by the lights from the two different directions that illuminate the layers to be etched by the optical system, and that are reflected on a boundary between the layers to be etched; and
a measurement section for measuring the etching depth based on the frequency of either of the two interfered lights received by the detector whichever meeting predetermined requirements.

15. The etching apparatus of claim 14, wherein the light emission section includes a light source for emitting a laser light.

16. The etching apparatus of claim 14, further comprising:
a determination section for determining whether the etching depth measured by the measurement section reaches a predetermined etching depth; and
a display section for displaying thereon, when the determination section determines that the etching depth reaches the predetermined etching depth, a message telling that the etching depth reaches the predetermined etching depth.

17. The etching apparatus of claim 14, further comprising:
a determination section for determining whether the etching-depth measured by the measurement section reaches a predetermined etching depth; and
a stop section for stopping, when the determination section determines that the etching depth reaches the predetermined etching depth, an etching operation for the layer to be etched.
